(19) United States
(12) Patent Application Publication
(10) Pub. No.: US 2026/0371442 A1
(43) Pub. Date: Nov. 19, 2026

(54) Information Relating to Performance of a Timing Service

(71) Applicant: Telefonaktiebolaget LM Ericsson (publ), Stockholm (SE)

(72) Inventors: Nianshan Shi, Järfälla (SE); Angelo Centonza, Granada Granada (ES); Mattias Bergström, Sollentuna (SE); Magnus Sandgren, Staffanstorp (SE); Olof Liberg, Enskede (SE)

(21) Appl. No.: 19/487,827

(22) PCT Filed: May 29, 2024
(86) PCT No.: PCT/SE2024/050529

§ 371 Date: Nov. 25, 2025

Related U.S. Application Data
(60) Provisional application No. 63/469,592, filed on May 30, 2023.

(51) Int. Cl. H04W 76/38; H04W 24/10; H04W 56/00

(52) U.S. Cl. CPC H04W 76/38; H04W 24/10; H04W 56/0045

(57) ABSTRACT

In an example, a method performed by a user equipment (UE) is provided The method comprises transmitting, to a first network node of a communication network, a report message comprising information relating to performance of a timing service provided to the UE by the communication network.

### TECHNICAL FIELD

Examples of this disclosure relate to information relating to performance of a timing service, such as for example transmission or obtaining of such information.

### BACKGROUND

The 3rd Generation Partnership Project (3GPP) has concluded the “Study on timing resiliency and TSC and URLLC enhancements,” V18.1.0, relating to time sensitive communications (TSC) and ultra-reliable low latency communications (URLLC). In regards to providing a Radio Access Network's (RAN's) latest clock quality information to a User Equipment (UE) in RRC_Connected state, this reference provides the following:
If a UE is subscribed for Access Stratum Time Synchronization (ASTI) in the Unified Data Management (UDM) (see clause 8.6), then the “Access and Mobility Subscription data” may additionally contain the following clock quality reporting control information:
   Clock quality detail level: indicates whether and which clock quality information to provide to the UE and can take one of the following values:
   clock quality metrics or acceptable/not acceptable indication; and Clock quality acceptance criteria for the UE (if the clock quality level equals “acceptable/not acceptable indication”: the clock quality acceptance criteria for the UE. Acceptance criteria can be defined based on the following attributes: time source, traceability to Universal Time Coordinated (UTC) or Global Navigation Satellite System (GNSS), synchronization state, clock accuracy, Precision Time Protocol (PTP) clockClass, frequency stability. (e.g. acceptable clock accuracy, acceptable frequency stability, etc.).
NOTE 4: Attributes that can be used for clock quality acceptance criteria depends on RAN capabilities to provide them and pending RAN working groups (WGs) feedback. Whether PTP clockClass can be used will be determined during the normative phase.
NOTE 5: Whether and which clock quality information to provide to the UE depends on the needs of the time service consumer (referred to as client network operator hereafter). Therefore, the clock quality detail level and clock quality acceptance criteria are based on the parameters and their values specified in the agreement between the 5G network operator and the client network operator. The clock quality acceptance criteria refer to the quality with which 5G access stratum time needs to be delivered to and received by the UE (i.e. also considering propagation delays). Additional inaccuracies in the UE, e.g. if the 5G access stratum time is delivered to devices attached to the UE, are not included in the clock quality acceptance criteria because they are assumed to be budgeted by the client network operator when agreeing the required clock accuracy with the 5G network operator.
If an Application Function (AF) requests Access Stratum Time Synchronization (ASTI) for a UE, then the AF may provide clock quality reporting control information and service acceptance criteria (defined based on the following attributes: time source, traceability to UTC or GNSS, synchronization state, clock accuracy, clockClass, frequency stability, NOTE 4) to TSC Time Synchronization Function (TSCTSF). TSCTSF provides the clock quality reporting control information to AMF.
When Access and Mobility Management Function (AMF) provides the 5G access stratum time distribution indication and the Uu time synchronization error budget to Next-Generation RAN (NG-RAN), AMF also includes the clock quality reporting control information.
Based on the clock quality reporting control information received from AMF, RAN reports its timing synchronization status to the UE using unicast Radio Resource Control (RRC):
   If clock quality detail level is set to “clock quality metrics”, then the RAN provides clock quality metrics to the UE that reflect its current timing synchronization status. Clock quality metrics refers to the following information: clock accuracy, PTP clockClass, traceability to UTC, frequency stability, time source, synchronization state.
   If clock quality detail level is set to “acceptable/not acceptable indication”, then the RAN provides an acceptable indication to the UE if the RAN's timing synchronization status matches the acceptance criteria received from AMF; otherwise RAN indicates “not acceptable” to the UE.
   When determining the clock quality metrics for a UE and when determining whether clock quality is acceptable or not acceptable for a UE, RAN considers whether propagation delay compensation is performed.

In view of the above, the following aspects related to a time synchronization status of a UE are highlighted:
1) The “clock quality reporting control information” sent by an AMF to a gNodeB (gNB) often manages the NG-RAN timing synchronization status notifications to the UE;
2) In some scenarios, if “clock quality metrics” is set, the gNB provides the clock quality metric to the UE, which reflects a gNB's current timing synchronization status;
3) In some scenarios, if “acceptable/not acceptable” indication is set, the gNB provides the indication according to if it matches the acceptance criteria sent from the AMF.
4) In some scenarios, attributes that can be used depend on RAN capabilities, time consumer needs and agreement between a 5G network operator and the client network operator.

There currently exist certain challenge(s). For example, there is currently no solution for the network to observe how well a TaaS service or services with low latency and high timing accuracy have been performing. This lack of observability prevents detection and root cause analysis, which is used to find measures to optimise a network configuration and/or optimise TaaS services for users in static and mobility conditions.

Furthermore, a lack of observability also prevents an operator from detecting whether service level agreements with users have been respected. This is important for aspects like charging. If there is a lack of observability of a TaaS service (or any other similar services provided to a UE, such as URLLC services), an operator may not be able to determine what charging policies should be applied to a user.

### SUMMARY

Certain aspects of the disclosure and their embodiments may provide solutions to these or other challenges.

One aspect of the present disclosure provides a method performed by a user equipment (UE). The method comprises transmitting, to a first network node of a communication network, a report message comprising information relating to performance of a timing service provided to the UE by the communication network.

Another aspect of the present disclosure provides a method performed by a first network node of a communication network. The method comprises obtaining information relating to performance of a timing service provided to one or more UEs by the communication network.

A further aspect of the present disclosure provides a method performed by a second network node of a communication network. The method comprises transmitting, to a first network node of the communication network, a report message comprising information relating to performance of one or more timing services provided to one or more UEs by the communication network.

Another aspect of the present disclosure provides apparatus in a User Equipment (UE). The apparatus comprises a processor and a memory. The memory contains instructions executable by the processor such that the apparatus is operable to transmit, to a first network node of a communication network, a report message comprising information relating to performance of a timing service provided to the UE by the communication network.

A further aspect of the present disclosure provides apparatus in a first network node of a communication network. The apparatus comprises a processor and a memory. The memory contains instructions executable by the processor such that the apparatus is operable to obtain information relating to performance of a timing service provided to one or more UEs by the communication network.

An additional aspect of the present disclosure provides apparatus in a second network node of a communication network. The apparatus comprises a processor and a memory. The memory contains instructions executable by the processor such that the apparatus is operable to transmit, to a first network node of the communication network, a report message comprising information relating to performance of one or more timing services provided to one or more UEs by the communication network.

A further aspect of the present disclosure provides apparatus in a User Equipment (UE). The apparatus is configured to transmit, to a first network node of a communication network, a report message comprising information relating to performance of a timing service provided to the UE by the communication network.

A further aspect of the present disclosure provides apparatus in a first network node of a communication network. The apparatus is configured to obtain information relating to performance of a timing service provided to one or more UEs by the communication network.

Another aspect of the present disclosure provides apparatus in a second network node of a communication network. The apparatus is configured to transmit, to a first network node of the communication network, a report message comprising information relating to performance of one or more timing services provided to one or more UEs by the communication network.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a method performed by a wireless device according to embodiments of the disclosure;

FIG. 2 shows a method performed by a network node according to embodiments of the disclosure;

FIG. 3 shows a method performed by a network node according to embodiments of the disclosure;

FIG. 4 shows an example of a communication system in accordance with some embodiments;

FIG. 5 shows a UE in accordance with some embodiments;

FIG. 6 shows a network node in accordance with some embodiments;

FIG. 7 is a block diagram of a host in accordance with various aspects described herein;

FIG. 8 is a block diagram illustrating a virtualization environment in which functions implemented by some embodiments may be virtualized;

FIG. 9 shows a communication diagram of a host communicating via a network node with a UE over a partially wireless connection in accordance with some embodiments; and

FIG. 10 shows a network node in accordance with further embodiments.

### DETAILED DESCRIPTION

Some of the embodiments contemplated herein will now be described more fully with reference to the accompanying drawings. Embodiments are provided by way of example to convey the scope of the subject matter to those skilled in the art.

It is understood that, whilst embodiments of the present disclosure may refer to TaaS services, specifically, they are also applicable more generally to embodiments in which timing services for Ultra Reliable and Low Latency Communication (URLLC) and/or time critical communication are utilized. Similarly, whilst specific reference to NG-RAN nodes may be made, embodiments of the present disclosure are also applicable to other types of RAN nodes (e.g., gNBs and/or eNBs).

In some examples, generally it is a client network and an end application (end station) using a Time-as-a-Service (TaaS) service. The end application can for example reside within a UE or it can have an external interface towards the UE. For evaluating a 5G System delivered TaaS service (and to evaluate different Time Distribution Alternatives, TDAs) in a closed loop approach, the end application/UE may need to compare the 5GS delivered TaaS service to another primary time source (e.g. a local Global Navigation Satellite System, GNSS, receiver's derived time). This may be possible, for example, in scenarios where 5GS is used as a back-up system and the end application/UE has its primary system operating with a known good performance. In order to achieve such comparison, the end application/UE may also need to be willing to share such relative measurements (with good quality). For example, the relative measurements may need to include a position of the UE when the measurements were performed. If measurements are taken at the end application, they may reflect the true end-to-end status (e.g., by including components outside of the 3GPP/5GS boundary for the SA defined 5GS synchronicity budget in TS 22.104). While measurements provided by the end application/UE are useful, the pre-conditions allowing for collection of such measurements may not always be fulfilled. Therefore, an approach for measuring a TaaS service performance without feedback from the end application/UE (i.e. an open loop approach) would be beneficial.

Currently, the network already assesses the status of TaaS services up to a UE antenna without end application/UE feedback involvement. However, this assessment does not account for a UE's internal error for a complete 5GS synchronicity budget status within its boundaries where UE egress point could be (e.g. for UE Device Side Time Sensitive Networking (TSN) Translators (DS-TT), UE internal accuracy capability class reporting may be needed for the assessment).

In some example scenarios, the UE/end application may have a primary source for timing information and may wish to use a TaaS service as a backup service to the primary source. However, for the backup service, an accurate time might not be needed; it could be sufficient for a UE/end application to maintain its time during a temporary interruption of its primary source using highly stable frequency or phase information delivered by the base station (e.g. gNB). In such cases, the quality of the service may be dependent upon the frequency/phase stability of the delivered information. That is, the TaaS service performance might not be limited to the ability to distribute accurate time information.

To summarize, both closed loop and open loop assessment of the performance of TaaS services may be beneficial.

Examples of this disclosure may include one or more of the following two parts:
One part is to obtain the observability, via a Core Network (CN) node, a UE, and/or a gNB, on how users are served by the network (e.g. to gain knowledge of whether time accuracy requirements were fulfilled).
Another part is to transfer this knowledge among Radio Access Network (RAN) nodes (e.g. gNBs), with or without Xn connection, so the RAN nodes in an area are made aware of how each RAN node and cells are handling the TaaS service. This knowledge can in some examples be built up and used to train and optimize TaaS services for users during mobility and other situations.

Certain embodiments may provide one or more of the following technical advantage(s). For example, embodiments of the present disclosure may improve the observability of TaaS services (e.g. it can be observed how a TaaS service has performed in the network/UE). The network can use this information to optimize the network configuration and operation, for example for mobility, UE traffic steering, Radio Resource Control (RRC) Idle cell selection, Propagation Delay Compensation (PDC) method selection, or time distribution alternatives (e.g. cell, broadcast/unicast)).

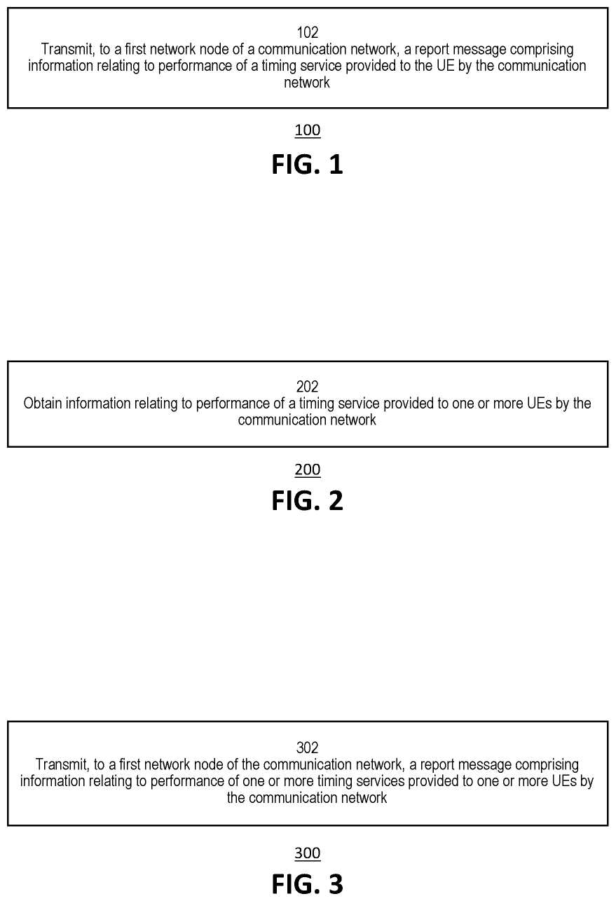

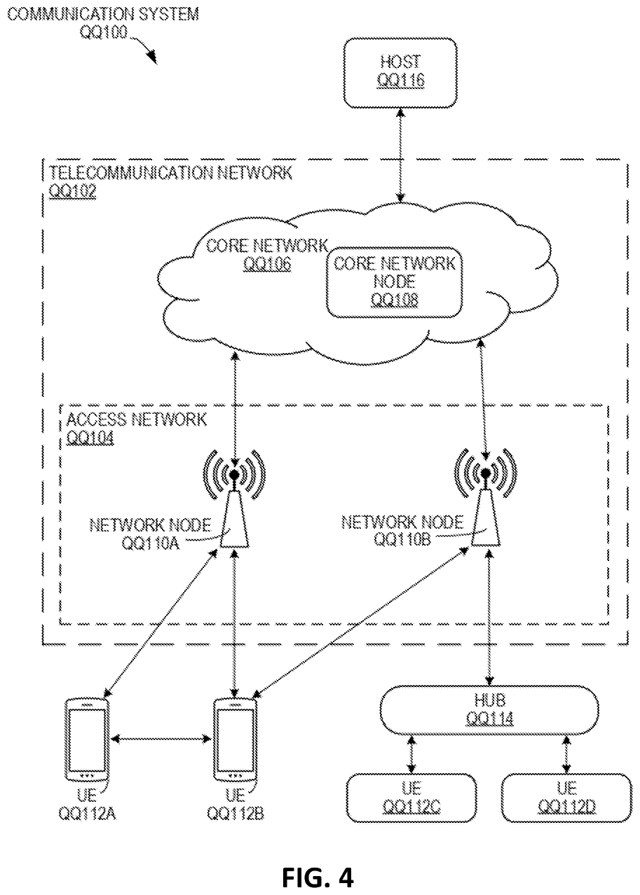

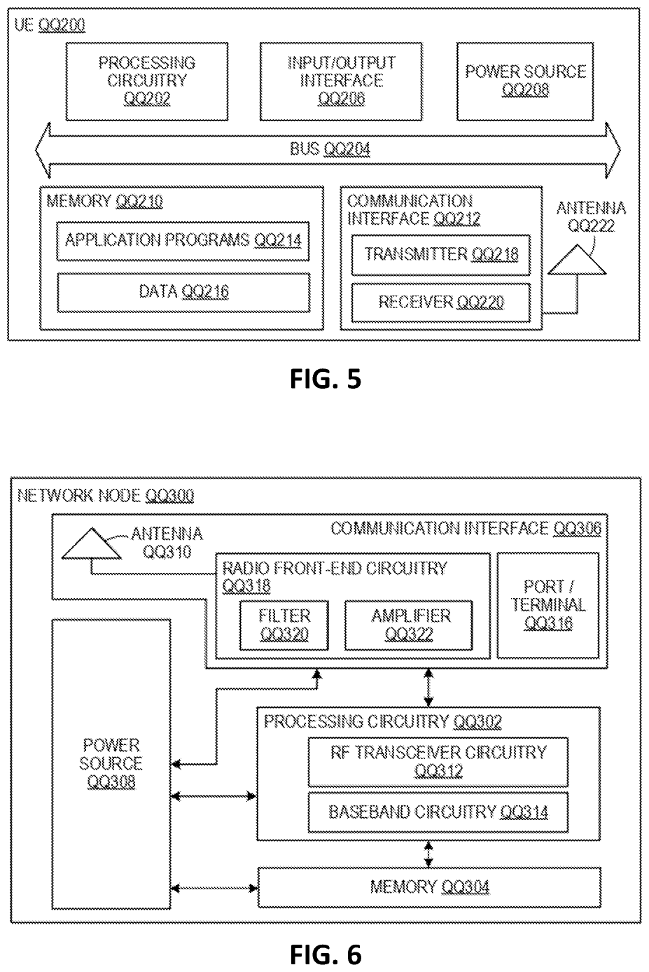

FIG. 1 depicts a 100 method in accordance with particular embodiments. The method 100 may be performed by a UE or wireless device (e.g. the UE QQ112 or UE QQ200 as described later with reference to FIGS. 4 and 5 respectively). The method begins at step 102 with the UE transmitting, to a first network node (e.g., a RAN node, such as an NG-RAN node) of a communication network, a report message comprising information relating to performance (e.g. a performance quality) of a timing service provided to the UE by the communication network. In some embodiments, the timing service may be one of: a TaaS service; a timing service used for URLLC; and a timing service used for time critical communication.

In some examples, the method 100 may also comprise collecting the information relating to the performance of the timing service provided to the UE by the communication network.

Collecting the information relating to the performance of the timing service may in some examples comprise performing a measurement procedure to measure the performance of the timing service; and may additionally or alternatively in some examples comprise receiving, from an end application connected to the UE, the information relating to the performance of the timing service.

The report message may transmitted to the first network node for example using Radio Resource Control (RRC) signaling. The report message may be for example a Minimization of Drive Test (MDT) report. In some examples, the report message may be transmitted to the first network node:
periodically;
responsive to the UE receiving, from the communication network, a request to transmit the report message to the first network node; and/or
responsive to an occurrence of an event, wherein the occurrence of the event triggers the UE to transmit the report message to the first network node.

The information relating to the performance of the timing service could in some examples be used to determine a propagation delay associated with the timing service and/or a propagation delay compensation between the UE and the first network node (e.g. the gNB).

In some examples, the information relating to the performance of the timing service comprises one or more of:
an internal timing accuracy of the UE;
an indication of a Quality of Service, QoS, or Quality of Experience, QoE, metric associated with the timing service;
an indication of an accuracy of time information provided to the UE for a QoS flow and/or the timing service.
an indication of a phase stability and/or a frequency stability of the timing service;
an indication that one or more requirements of the timing service provided to the UE were fulfilled;
an indication that one or more requirements of the timing service provided to the UE were not fulfilled;
an indication that the timing service provided to the UE was subject to one or more temporary interruptions;
an indication that the timing service provided to the UE was subject to a permanent failure;
an indication of a confidence level of the UE in one or more estimates of a quality of the timing service;
an indication of a position of the UE when performing a measurement procedure to measure the performance of the timing service;
an indication of a time at which the UE performs a measurement procedure to measure the performance of the timing service; and
an indication of one or more radio channel conditions observed by the UE whilst performing a measurement procedure to measure the performance of the timing service.

Example implementations of the method 100 of FIG. 1 are discussed in more detail in the following paragraphs.

In some embodiments, the UE may be requested by the communication network to collect information relating to the performance of the timing service. For example, a new measurement may be defined which enables the UE to collect information relating to the performance of a timing service (which may also referred to as “feedback”, “evaluation”, and/or “TaaS related information”) indicating how a TaaS service is being/has been performed, such that this information may be sent to network nodes of the communication network. For example, in some embodiments, a network node may request a UE to report this new measurement (e.g., its TaaS service experience/QoE). In some embodiments, a new QoE measurement on a TaaS service may be requested by an application (e.g. via QoE configuration metrics). In such embodiments, a network may introduce RAN-visible QoE (RVQoE).

Therefore, in some embodiments, prior to step 102, the UE may collect information relating to the performance of the timing service. For example, in some embodiments, the UE may: perform a measurement procedure to measure the performance of the timing service; and/or receive, from an end application connected to the UE, the information relating to the performance of the timing service.

That is, in some embodiments, an end application behind the UE (i.e., an end application connected to the UE) using the timing service may: perform an evaluation of the performance of a TaaS service; provide a comparison between the TaaS service and an alternative time source when different time sources are used by the end application; and/or provide the UE with a reference source for performing such a comparison.

The above discussed feedback/evaluation/TaaS related information may then be sent to network nodes of a communication network (e.g., during step 102). That is, once the UE has collected the information, it may deliver it to the network (e.g. via RRC signaling) upon request from the network. For example, in some embodiments, the report message of step 102 may be transmitted to the first network node using RRC signaling.

In some embodiments, the measurements collected by the UE may be reported to a RAN node directly (e.g. in a way similar to RRM measurements reported via RRC protocols) or they may be reported to the (NG-)RAN node in the form of measurements reports and/or logs that may be forwarded by the (NG-)RAN node to other systems (e.g., to an Operations, Administration, and Management, OAM, system). The latter example can map to the inclusion of the feedback/evaluation/TaaS related information in Minimisation of Drive Test (MDT) measurements. In such embodiments, the UE may report the feedback/evaluation/TaaS related information to an (NG-)RAN node as part of one or more MDT reports (and the RAN node may signal the feedback/evaluation/TaaS related information to an OAM system). In other words, the report message of step 102 may be an MDT report. The (NG-)RAN node may in some examples be capable of using the feedback/evaluation/TaaS related information reported by the UE as MDT reports are decodable to RAN nodes.

In some embodiments, the network (e.g., the first network node of method 100) may request that the UE transmits its information on demand, periodically, or based on the occurrence of one or more events. For example, the report message of step 102 may be transmitted to the first network node according to any one or more of the following: periodically; responsive to the UE receiving (from the communication network) a request to transmit the report message to the first network node; and responsive to an occurrence of an event. That is, the occurrence of an event may trigger the UE to transmit the report message to the first network node.

In some embodiments, once the first network node has received the feedback/evaluation/TaaS related information, a network node may analyze the measurement results and/or the RVQoE for TaaS in order to understand how TaaS services are being received at the user side.

For example, in some embodiments, the information relating to the performance of the timing service may relate to a performance quality of the timing service. In some embodiments, the information relating to the performance of the timing service may be used to determine a propagation delay associated with the timing service and/or a propagation delay compensation between the UE and the first network node.

Non-limiting examples of the TaaS related information provided by the measurements discussed above (i.e., the information relating to the performance of the timing service) are:
The accuracy of time information provided in a Cell for a specific QoS flow/service. Additionally or alternatively, a phase/frequency stability of a timing service if used as a backup service.
Whether requirements for a TaaS service in use by the UE/end application were fulfilled or not fulfilled.
Whether one or more TaaS services in use by the UE/end application were subject to temporary interruptions (e.g., how many interruption the service was subject to and how long each interruption lasted).
Whether one or more TaaS services in use by the UE were subject to permanent failures causing a service drop.
The confidence in TaaS service quality estimates (e.g. the quality of an alternative reference time source used for comparison).
a UE's position (potentially with an estimate of the position accuracy) and time at which a TaaS service was evaluated.
Information related to radio channel conditions (observed by the UE) during a TaaS service quality observation.

The UE position/location information provided during a TaaS service (e.g., provided to the first network node) may for example to help the communication network build up knowledge of how cells in a deployed area are performing.

The method of FIG. 1 enables TaaS observability among network entities to be improved. In one example of a UE enabling the transfer of TaaS observability among network entities, existing RRC information may be modified to include TaaS related information (e.g. in “NR Mobility History Report”, see Table 1 below). Table 1 illustrates an embodiment in which TaaS related information is included in a “UE history information from UE” information element (IE). As seen from Table 1, this IE contains information about mobility history report for a UE.

TABLE 1
UE History Information from the UE (9.2.3.110)

| | | | | |
|---|---|---|---|---|
| | | | IE type and | |
| IE/Group Name | Presence | Range | reference | Semantics description |

| | | | |
|---|---|---|---|
| CHOICE UE | M | | |
| History Information | | | |
| from the UE | | | |
| >NR | | | |
| >>NR Mobility | M | OCTET | Include TaaS related |
| History Report | | STRING | measurement or QoE |
| | | | in (TS 38.331 [10]). |

As can be appreciated from Table 1, when information relating to performance of a timing service is included in UE history information from UE (or other similar signaling), this information can be transferred among (NG-)RAN nodes using existing procedures.

FIG. 2 depicts a method 200 in accordance with particular embodiments. The method 200 may be performed by a first network node (e.g., a RAN node, such as an NG-RAN node) of a communications network node (e.g. the network node QQ110 or network node QQ300 as described later with reference to FIGS. 4 and 6 respectively). The method begins at step 202 with the first network node obtaining information relating to performance of a timing service provided to one or more UEs by the communication network. In some embodiments, the one or more timing services may be any one or more of: a TaaS service; a timing service used for URLLC; and a timing service used for time critical communication.

In some examples, the information relating to the performance of the one or more timing services may be forwarded to one or more network nodes in the communication network. The one or more network nodes may comprise for example one or more RAN nodes in the communication network; one or more RAN nodes which neighbor the first network node; and/or one or more Core Network (CN) nodes in the communication network.

The Information relating to the performance of the one or more timing services may be included in some examples in at least one of:
a cell information update transmitted during inter node communication;
resource information transmitted during inter node communication; and
UE history information transmitted during a mobility procedure.

In some examples, the method may further comprise performing one or more actions concerning the one or more timing services based on the information relating to the performance of the one or more timing services. The one or more actions may be for example optimizing the one or more timing services in order to fulfill one or more requirements of the one or more timing services; and/or interrupting the one or more timing services.

In some examples, obtaining the information relating to the performance of the one or more timing services in step 202 may comprises at least one of the following actions:
receiving one or more report messages from the one or more uEs, wherein the one or more report messages comprise the information relating to the performance of the one or more timing services;
receiving a report message from a second network node, wherein the report message comprises the information relating to the performance of the one or more timing services; and
performing a measurement procedure to measure the performance of the one or more timing services.

The report message may in some examples be received by the first network node:
periodically;
responsive to the first network node transmitting, to a second network node, a request for the second network node to transmit the report message to the first network node; and/or
responsive to an occurrence of an event, wherein the occurrence of the event triggers a second network node and/or the one or more uEs to transmit the report message to the first network node.

In some examples, the information relating to the performance of the timing service can be used to determine one or more propagation delays associated with the one or more timing services and/or one or more propagation delay compensations between the one or more uEs and the first network node. For example, information as to whether and what kind of propagation delay compensation is used may be useful to 1) assess the received information of a performance of a timing service (e.g. the performance may be dependent of on a particular method used); and/or 2) understand what potential optimizations could be used to potentially improve the service.

In some examples, the information relating to the performance of the one or more timing services may comprise one or more of the following examples:
an indication of a Quality of Service, QoS, metric or a Quality of Experience, QoE, metric associated with the one or more timing services;
an indication of an accuracy of time information provided to the one or more uEs or a second network node for a QoS flow and/or the timing service.
an indication of a phase stability and/or a frequency stability of the one or more timing services;
an indication that one or more requirements of the one or more timing services provided to the one or more uEs were fulfilled;
an indication that one or more requirements of the one or more timing services provided to the one or more uEs were not fulfilled;
an indication that the one or more timing services provided to the one or more uEs were subject to one or more temporary interruptions;
an indication that the one or more timing services provided to the one or more uEs were subject to one or more permanent failures;
an indication of a confidence level of the one or more uEs or a second network node in one or more estimates of a quality of the one or more timing services;
an indication of a position of the one or more uEs when a measurement procedure to measure the performance of the timing service is performed by the one or more uEs;
an indication of a time at which a measurement procedure to measure the performance of the one or more timing service is performed by the one or more uEs or a second network node;
an indication of one or more radio channel conditions observed by the one or more uEs whilst performing a measurement procedure to measure the performance of the timing services; and
an indication of one or more radio channel conditions observed by a second network node whilst performing a measurement procedure to measure the performance of the one or more timing services.

In some examples, the information relating to the performance of the one or more timing services is transmitted to the first network node from the one or more uEs using Radio Resource Control (RRC) signaling. The information relating to the performance of the one or more timing services may in some examples be transmitted to the first network node from the one or more uEs in one or more Minimisation of Drive Test (MDT) reports.

Example implementations of the method of FIG. 2 are discussed in more detail in the following paragraphs.

In some embodiments, step 202 comprises an (NG-)RAN node collecting “TaaS performance information” (i.e., information relating to the performance of the one or more timing services provided to the one or more uEs) indicating how TaaS service users are being served (e.g., on a per cell level). For example, in some embodiments, this may comprise the first network node performing any one of the following:
receiving one or more report messages from the one or more uEs, wherein the one or more report messages comprise the information relating to the performance of the one or more timing services;
receiving a report message from a second network node, wherein the report message comprises the information relating to the performance of the one or more timing services; and
performing a measurement procedure to measure the performance of the one or more timing services.

In some embodiments where the first network node receives one or more report messages from a second network node or the one or more uEs, the one or more report messages may be received by the first network node according to any one or more of the following: periodically; responsive to the first network node transmitting, to a second network node or the one or more uEs, a request for the second network node or the one or more uEs to transmit the report message to the first network node; and/or responsive to an occurrence of an event. That is, the occurrence of the event may trigger the one or more uEs or a second network node to transmit the report message to the first network node.

In some embodiments, the information relating to the performance of the one or more timing services may be transmitted to the first network node from the one or more uEs using RRC signaling. Additionally or alternatively, the information relating to the performance of the one or more timing services may be transmitted to the first network node from the one or more uEs in one or more MDT reports.

In some embodiments, the information relating to the performance of the one or more timing services (also referred herein as “TaaS performance information”) may be used to determine one or more propagation delays associated with the one or more timing services and/or one or more propagation delay compensations between the one or more uEs and the first network node. In some embodiments, the information relating to the performance of the one or more timing services relates to a performance quality of the one or more timing services. For example, the TaaS performance information may include a cell's clock quality, time accuracy, and/or how many uEs are being served. The TaaS performance information may be derived via new or existing measurement/information.

Accurate time distribution from a gNB (or any other suitable RAN node), for example, to a UE is dependent on the ability of the network (e.g. a UE or a gNB) to compensate for the propagation delay (PD) between the gNB and the UE. Part of the information collected by the network for monitoring TaaS performance is hence the PD between the serving gNB and the UE, as well as the PD between neighboring gNBs and the UE.

The PD accuracy is dependent on the radio channel between the gNB and the UE, methods used for Propagation Delay Compensation (PDC) and the capability of supporting various PDC methods. In some methods line of sight (LOS) conditions the PD can be estimated with high accuracy by a gNB, while in non-LOS (NLOS) conditions such method may be more challenging to obtain high accuracy in the PDC. Information related to the radio channel, such as if it's a LOS or NLOS radio channel is therefore collected by the network for monitoring and evaluating expected TaaS performance. Another PDC method specified in 3GPP which may be supported is a Round Trip Time (RTT) measurements where LOS is not needed but requires support at both the gNB and the UE. The performance is dependent, for example, on the level of radio channel symmetry in downlink and uplink and gNB/UE relative receive/transmit time accuracies.

To support PD estimation towards a neighboring non-serving gNB, the serving gNB may trigger the UE to synchronize and transmit a random access preamble (PRACH) towards a non-serving gNB. The non-serving gNB can based on reception of the preamble estimate the PD between the UE and the gNB.

The accuracy in the TaaS service may also depend on the method to distribute time information over the air interface like whether using a broadcast method like SIB 9 or a unicast signaling. The periodicity of the time distribution and, for example, characteristics of time reference signals like bandwidth may also impact the time distribution accuracy for the air interface and may be used as input for estimates. Radio channel conditions in the cell may also impact the TaaS performance and may be used as an evaluation criteria.

Therefore, in some embodiments, the information relating to the performance of the timing service may be used to determine one or more propagation delays associated with the one or more timing services and/or one or more propagation delay compensations between the one or more UEs and the first network node. In some embodiments, the information relating to the performance of the one or more timing services relates to a performance quality of the one or more timing services. In some embodiments, the information relating to the performance of the timing service may comprise the information discussed in relation to the methods of FIG. 1 above and FIG. 3 below.

In some embodiments, an (NG-)RAN node may transfer this information/knowledge (e.g. estimated PDC method and related accuracy) to the other (NG-)RAN nodes (e.g., during mobility to the target (NG-)RAN node). That is, an (NG-)RAN node may transfer the information received from the TaaS feedback from the UE and include it in messages. This enables RAN nodes in an area (e.g., gNBs) to be aware of TaaS service handling.

For example, in some embodiments, once a (NG-)RAN node has obtained TaaS performance Information, it may share this information with other (NG-)RAN nodes during inter-node communication. In other words, in some embodiments, the information relating to the performance of the one or more timing services obtained in step 202 may be forwarded to one or more network nodes in the communication network (e.g., one or more RAN nodes in the communication network; one or more RAN nodes which neighbor the first network node; and/or one or more CN nodes in the communication network).

For example, in some embodiments, the TaaS performance Information for a cell may be included in a cell information update or in resource information. In other embodiments, the collected TaaS performance information is transmitted during a mobility procedure. For example, collected TaaS performance information for a cell may be included as Cell TaaS information in UE history information (see Table 2 below). Table 2 illustrates an embodiment in which “Cell TaaS Information” is included in UE history information using an IE. The IE may contain, for example, information on the cell clock quality, time accuracy, UE time accuracy control metrics, external time source traceability, etc.

TABLE 2
Last Visited NG-RAN Cell Information (TS 38.413/38.423, 9.3.1.97)

| | | | IE type | | | |
|---|---|---|---|---|---|---|
| IE/Group | | | and | Semantics | | Assigned |
| Name | Presence | Range | reference | description | Criticality | Criticality |
| Global Cell | M | | NG-RAN | | — | |
| ID | | | CGI | | | |
| | | | 9.3.1.73 | | | |
| Cell Type | M | | 9.3.1.98 | | — | |
| Time UE | M | | INTEGER | | — | |
| Stayed in | | | (0 . . . 4095) | | | |
| Cell | | | | | | |
| Time UE | O | | INTEGER | | — | |
| Stayed in | | | (0 . . . 40950) | | | |
| Cell | | | | | | |
| Enhanced | | | | | | |
| Granularity | | | | | | |
| HO Cause | O | | Cause | | — | |
| Value | | | 9.3.1.2 | | | |
| Last | | 0 . . . <maxnoofPSCellsPerPri- | | | YES | ignore |
| Visited | | maryCellinUEHistoryInfo> | | | | |
| PSCell List | | | | | | |
| >Last | M | | 9.3.1.235 | The PSCell | — | |
| Visited | | | | related | | |
| PSCell | | | | information. | | |
| Information | | | | | | |
| Cell TaaS | O | | New IE | Containing | | |
| Information | | | structure | e.g. Clock | | |
| | | | | quality; UE | | |
| | | | | time | | |
| | | | | accuracy | | |
| | | | | control | | |
| | | | | metrics; the | | |
| | | | | external | | |
| | | | | time source | | |
| | | | | traceability | | |

The UE internal accuracy reported to the gNB as, for example, UE capability can be received by RAN nodes (e.g., gNBs) and transferred to the neighbor RAN nodes (e.g., gNBs) either in an RRC container or explicitly over the Xn/F1 interface.

In some embodiments, the first network node may perform one or more actions concerning the one or more timing services based on the information relating to the performance of the one or more timing services. In some embodiments, this may include optimizing the one or more timing services in order to fulfill one or more requirements of the one or more timing services; and/or interrupting the one or more timing services.

For example, a RAN node may use the information to determine a suitable list of candidate cells to perform handover (HO) to for maintaining accurate TaaS. Neighboring cells that are not able to deliver a PD under LOS conditions can, for example, be considered with lower priority at a HO compared to cells that do deliver a PD under LOS conditions. In some embodiments, cells that cannot support an accurate RTT-based PDC method may be considered, for example, with lower priority than cells that can. If there is a lack of proper methods for performing PDC, in some embodiments, smaller cells may be prioritized over larger cells.

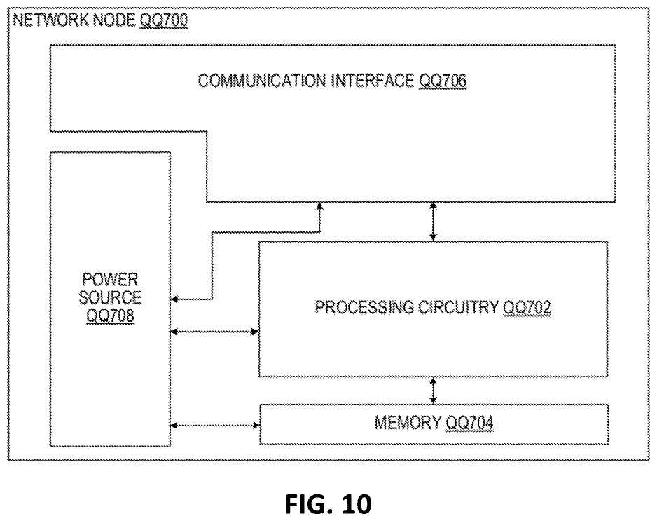

FIG. 3 depicts a method 300 in accordance with particular embodiments. The method 300 may be performed by a second network node (e.g., a core network node, such as an AMF) of a communication network (e.g. the core network node QQ108 or network node QQ700 as described later with reference to FIGS. 4 and 10 respectively). The method begins at step 302 with the second network node transmitting, to a first network node of the communication network (e.g., a RAN node, such as an NG-RAN node), a report message comprising information relating to performance of one or more timing services provided to one or more UEs by the communication network. In some embodiments, the one or more timing services may be any one or more of: a TaaS service; a timing service used for URLLC; and a timing service used for time critical communication.

In some examples, the method 300 may further comprise collecting the information relating to the performance of the one or more timing services provided to the one or more UEs by the communication network. The information relating to the performance of the one or more timing services may be collected for example from an application layer of the communication network.

In some examples, the information relating to the performance of the one or more timing services is collected whilst the one or more timing services are being provided to the one or more UEs. Additionally or alternatively, the information relating to the performance of the one or more timing services may in some examples be collected after provision of the one or more timing services to the one or more UEs has stopped.

In some examples, the report message is transmitted to the first network node:
periodically;
responsive to the second network node receiving, from the communication network, a request for the second network node to transmit the report message to the first network node; and/or
responsive to an occurrence of an event, wherein the occurrence of the event triggers the second network node to transmit the report message to the first network node.

In some examples, the information relating to the performance of the timing service can be used to determine one or more propagation delays associated with the one or more timing services and/or one or more propagation delay compensations between the one or more UEs and the first network node.

The information relating to the performance of the timing service may comprises one or more of the following examples:
an indication of a Quality of Service, QoS, or Quality of Experience, QoE, associated with the one or more timing services;
an indication of an accuracy of time information provided to the second network node for a QoS flow and/or the one or more timing services;
an indication of a phase stability and/or a frequency stability of the one or more timing services;
an indication that one or more requirements of the one or more timing service provided to the one or more UEs were fulfilled;
an indication that one or more requirements of the one or more timing services provided to the one or more UEs were not fulfilled;
an indication that the one or more timing services provided to the one or more UEs were subject to one or more temporary interruptions;
an indication that the one or more timing services provided to the one or more UEs were subject to one or more permanent failures;
an indication of a confidence level of the second network node in one or more estimates of a quality of the one or more timing services;
an indication of a time at which the second network node performs a measurement procedure to measure the performance of the timing service; and
an indication of one or more radio channel conditions observed by the second network node whilst performing a measurement procedure to measure the performance of the one or more timing services.

The information relating to the performance of the timing services may in some examples be specific to:
the one or more UEs;
one or more Packet Data Unit, PDU, Sessions for the one or more UEs;
one or more Quality of Service, QoS, Flows for one or more PDU Sessions for the one or more UEs; or
a UE group, wherein the UE group comprises the one or more UEs.

Example implementations of the method 300 of FIG. 3 are discussed in more detail in the following paragraphs.

In some embodiments, the second network node may collect the information relating to the performance of the one or more timing services (i.e., perform a “performance check”). In some embodiments, the application layer may be targeted to perform this performance check. In other words, the information relating to the performance of the one or more timing services may be collected (i.e., measured), by the second network node, from an application layer of the communication network.

In some embodiments, the performance check may involve the second network node checking how a UE TaaS service is being/has been performed and/or what a clock quality accuracy is.

Feedback information regarding the performance check (i.e., information relating to the performance of the one or more timing services) may be transferred from the application layer to an (NG-)RAN node (via an AMF) so as to create observability at the (NG-)RAN on how the TaaS service is being/has been performed (e.g., as part of step 302). In some embodiments, the performance check may be on a PDU session, a QoS flow, a service level, or per user plane tunnel.

In some embodiments, the (NG-)RAN node may use an NG Application Protocol (NGAP) procedure (or any other similar protocol procedure) to perform any one or more of the following:
subscribe to receiving feedback information regarding the performance check,
start/stop receiving the feedback information regarding the performance check; and
request periodic reporting of the feedback information regarding the performance check.

In some embodiments, the report message of step 302 may be transmitted to the first network node according to any one or more of the following: periodically; responsive to the second network node receiving (from the communication network) a request to transmit the report message to the first network node; and/or responsive to an occurrence of an event. That is, the occurrence of the event may trigger the second network node to transmit the report message to the first network node.

The performance checking may be:
1) carried on during the service (i.e., information relating to the performance of the one or more timing services is collected from an application layer of the communication network), or
2) collected after the service is completed (i.e., information relating to the performance of the one or more timing services is collected after provision of the one or more timing services to the one or more UEs has stopped).

In the embodiment of 1), the second network node (e.g., an AMF) may signal the performance check results/feedback during the consumption of the TaaS service to an (NG-) RAN node. This may happen in a periodic way via reports signalled to the (NG-)RAN node.

In the embodiment of 2) the second network node (e.g., an AMF) may signal, to a RAN node, a single message containing the logged results of the performance check.

In any of the above embodiments, and as a non-limiting example, the performance check results may be signalled in any one or more of the following ways:
With UE level granularity (i.e., the results may be associated with a specific UE);
With PDU Session granularity (i.e., the results may be associated with a specific PDU Session for a UE);
With QoS Flow level granularity (i.e., the results may be associated with a specific QoS Flow for a PDU Session and for a UE); and
With the granularity of a UE group (e.g., where the performance check is averages the performance of a group of UEs and services used by such UEs. In this embodiment, the performance check measurements for each UE may be taken as per any of the options above (per UE, per PDU Session or per QoS flow)).

For example, in some embodiments, the information relating to the performance of the timing service may relate to a performance quality of the timing service. In some embodiments, the information relating to the performance of the timing service may be used to determine a propagation delay associated with the timing service and/or a propagation delay compensation between the second network node and the first network node.

Non-limiting examples of the TaaS related information provided by the measurements discussed above (i.e., the information relating to the performance of the timing service) are:
With what accuracy time information has been provided in a Cell for a specific QoS flow/service. Additionally or alternatively, a phase/frequency stability of a timing service if used as a backup service.
Whether requirements for a TaaS service in use by the UE/end application were fulfilled or not fulfilled.
Whether one or more TaaS services in use by the UE/end application were subject to temporary interruptions (e.g., how many interruption the service was subject to and how long each interruption lasted).
Whether one or more TaaS services in use by the UE were subject to permanent failures causing a service drop.
The confidence in TaaS service quality estimates (e.g. the quality of an alternative reference time source used for comparison).
a UE's position (potentially in addition to accuracy estimates) and time at which a TaaS service was evaluated.
Information related to radio channel conditions (observed by the second network node) during a TaaS service quality observation.

Upon receiving the performance check measurements, an (NG-)RAN node may use it to determine how TaaS services are performing and whether any optimization is possible to fulfil TaaS service requirements. Additionally or alternatively, the (NG-)RAN node may decide to interrupt one or more TaaS services if their performances are not satisfactory or not meeting TaaS service requirements.

In some embodiments, an (NG-)RAN node may forward the results of the performance check to neighbour (NG-)RAN nodes. For example, the results may be forwarded over an available interface (e.g. the Xn). Due to this signalling, neighbour RAN nodes can be made aware of the quality with which TaaS services can be supported at the source (NG-)RAN node (in an end to end way). As explained below, this information enables neighbour (NG-) RAN nodes to better select mobility target cells for UEs that are using, or are likely to use, TaaS services.

FIG. 4 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system

QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example illustrated in FIG. 4, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 5 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIG. 1.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIG. 2.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 6 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 10 shows a network node QQ700 in accordance with some embodiments. As used herein, network node refers to equipment capable, configured, arranged and/or operable to communicate directly or indirectly with a UE and/or with other network nodes or equipment, in a telecommunication network. The network node QQ700 may be operable as a core network node, a core network function or, more generally, a core network entity, such as the core network node QQ108 described above with respect to FIG. 4). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node QQ700 includes processing circuitry QQ702, a memory QQ704, a communication interface QQ706, and a power source QQ708, and/or any other component, or any combination thereof. The network node QQ700 may be composed of multiple physically separate components, which may each have their own respective components. In certain scenarios in which the network node QQ700 comprises multiple separate components, one or more of the separate components may be shared among several network nodes.

The processing circuitry QQ702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ700 components, such as the memory QQ704, network node QQ700 functionality. For example, the processing circuitry QQ702 may be configured to cause the network node to perform the methods as described with reference to FIG. 3.

The memory QQ704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ702. The memory QQ704 may store any suitable instructions, data, or information, including a computer program, software, an application including one or more of logic, rules, code, tables, and/or other instructions capable of being executed by the processing circuitry QQ702 and utilized by the network node QQ700. The memory QQ704 may be used to store any calculations made by the processing circuitry QQ702 and/or any data received via the communication interface QQ706. In some embodiments, the processing circuitry QQ702 and memory QQ704 is integrated.

The communication interface QQ706 is used in wired or wireless communication of signaling and/or data between a network node, access network, and/or UE.

The power source QQ708 provides power to the various components of network node QQ700 in a form suitable for the respective components (e.g., at a voltage and current level needed for each respective component). The power source QQ708 may further comprise, or be coupled to, power management circuitry to supply the components of the network node QQ700 with power for performing the functionality described herein. For example, the network node QQ700 may be connectable to an external power source (e.g., the power grid, an electricity outlet) via an input circuitry or interface such as an electrical cable, whereby the external power source supplies power to power circuitry of the power source QQ708. As a further example, the power source QQ708 may comprise a source of power in the form of a battery or battery pack which is connected to, or integrated in, power circuitry. The battery may provide backup power should the external power source fail.

Embodiments of the network node QQ700 may include additional components beyond those shown in FIG. 10 for providing certain aspects of the network node's functionality, including any of the functionality described herein and/or any functionality necessary to support the subject matter described herein. For example, the network node QQ700 may include user interface equipment to allow input of information into the network node QQ700 and to allow output of information from the network node QQ700. This may allow a user to perform diagnostic, maintenance, repair, and other administrative functions for the network node QQ700.

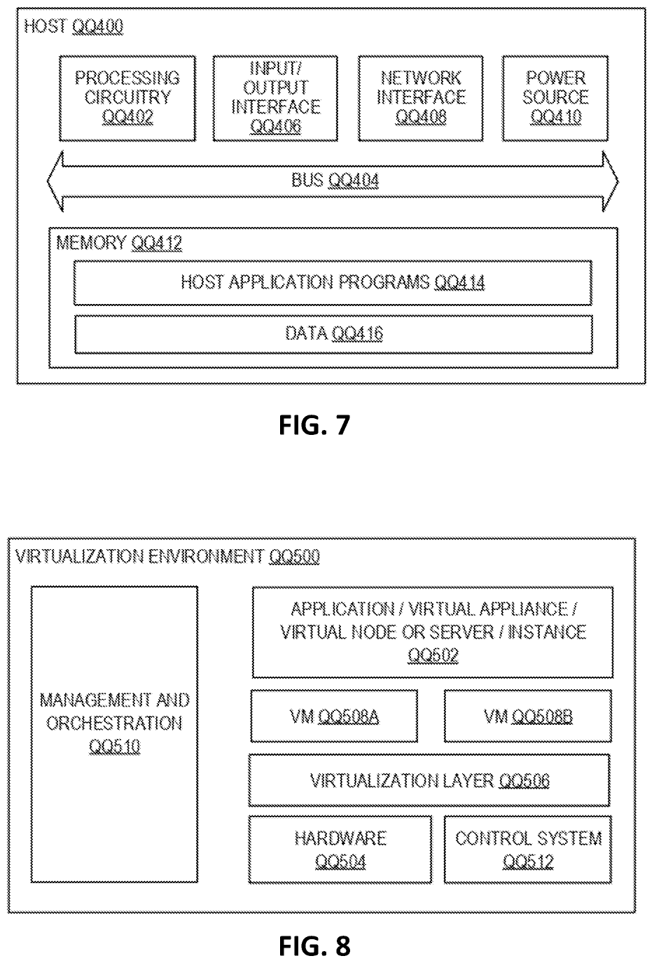

FIG. 7 is a block diagram of a host QQ400, which may be an embodiment of the host QQ116 of FIG. 4, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 5 and 6, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

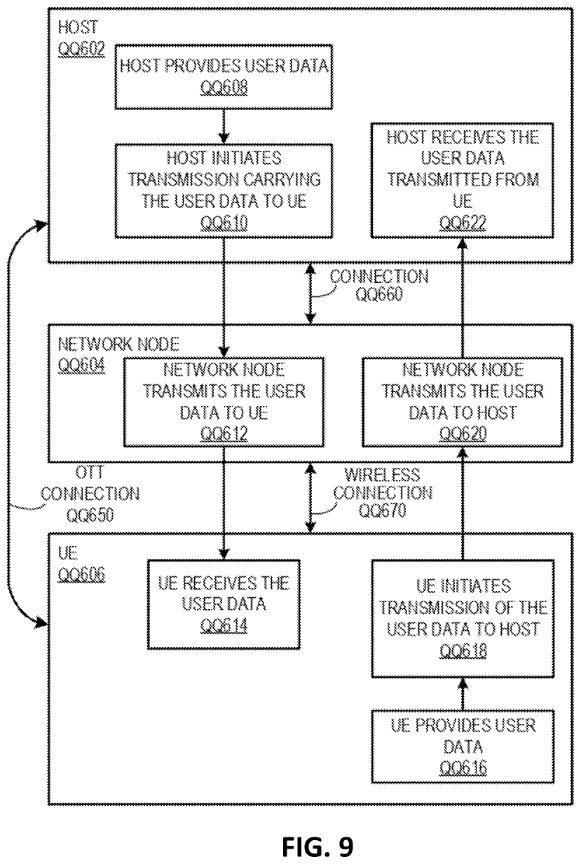

FIG. 9 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 4 and/or UE QQ200 of FIG. 5), network node (such as network node QQ110a of FIG. 4 and/or network node QQ300 of FIG. 6), and host (such as host QQ116 of FIG. 4 and/or host QQ400 of FIG. 7) discussed in the preceding paragraphs will now be described with reference to FIG. 9.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 4) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the observability of timing services provided to UEs by a communication network and thereby provide benefits such as enabling improved network optimization.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-54. (canceled)

55. A method performed by a user equipment (UE), the method comprising:
collecting information relating to the performance of the timing service provided to the UE by the communication network;
transmitting, to a first network node of a communication network, a report message comprising the information relating to performance of the timing service provided to the UE by the communication network;
wherein collecting the information relating to the performance of the timing service comprises at least one of:
performing a measurement procedure to measure the performance of the timing service; and
receiving, from an end application connected to the UE, the information relating to the performance of the timing service.

56. The method of claim 55, wherein the report message is a Minimization of Drive Test (MDT) report.

57. The method of claim 55, wherein the information relating to the performance of the timing service can be used to determine a propagation delay associated with the timing service and/or a propagation delay compensation between the UE and the first network node.

58. The method of claim 55, wherein the information relating to the performance of the timing service relates to a performance quality of the timing service and wherein the information relating to the performance of the timing service comprises one or more of:
an internal timing accuracy of the UE;
an indication of a Quality of Service (QoS) or Quality of Experience (QoE) metric associated with the timing service;
an indication of an accuracy of time information provided to the UE for a QoS flow and/or the timing service.
an indication of a phase stability and/or a frequency stability of the timing service;
an indication that one or more requirements of the timing service provided to the UE were fulfilled;
an indication that one or more requirements of the timing service provided to the UE were not fulfilled;
an indication that the timing service provided to the UE was subject to one or more temporary interruptions;
an indication that the timing service provided to the UE was subject to a permanent failure;
an indication of a confidence level of the UE in one or more estimates of a quality of the timing service;
an indication of a position of the UE when performing a measurement procedure to measure the performance of the timing service;
an indication of a time at which the UE performs a measurement procedure to measure the performance of the timing service; and
an indication of one or more radio channel conditions observed by the UE whilst performing a measurement procedure to measure the performance of the timing service.

59. The method of claim 55, wherein the timing service is:
a Time-as-a-Service (TaaS) service;
a timing service used for Ultra Reliable and Low Latency Communication (URLLC); or
a timing service used for time critical communication.

60. A method performed by a first network node of a communication network, the method comprising:
obtaining information relating to performance of a timing service provided to one or more UEs by the communication network; and
performing one or more actions concerning the one or more timing services based on the information relating to the performance of the one or more timing services.

61. The method of claim 60, wherein the information relating to the performance of the one or more timing services is forwarded to one or more network nodes in the communication network.

62. The method of claim 61, wherein the one or more network nodes comprise:
one or more RAN nodes in the communication network;
one or more RAN nodes which neighbor the first network node; and/or
one or more Core Network (CN) nodes in the communication network.

63. The method of claim 60, wherein the information relating to the performance of the one or more timing services is included in at least one of:
a cell information update transmitted during inter node communication;
resource information transmitted during inter node communication; and
UE history information transmitted during a mobility procedure.

64. The method of claim 60, wherein the one or more actions comprises any one of:
optimizing the one or more timing services in order to fulfill one or more requirements of the one or more timing services; and
interrupting the one or more timing services.

65. The method of claim 60, wherein obtaining the information relating to the performance of the one or more timing services comprises at least one of:
receiving one or more report messages from the one or more UEs, wherein the one or more report messages comprise the information relating to the performance of the one or more timing services;
receiving a report message from a second network node, wherein the report message comprises the information relating to the performance of the one or more timing services; and
performing a measurement procedure to measure the performance of the one or more timing services.

66. The method of claim 60, wherein the timing service is:
a Time-as-a-Service (TaaS) service;
a timing service used for Ultra Reliable and Low Latency Communication (URLLC); or
a timing service used for time critical communication.

67. The method of claim 60, wherein the information relating to the performance of the timing service can be used to determine one or more propagation delays associated with the one or more timing services and/or one or more propagation delay compensations between the one or more UEs and the first network node.

68. The method of claim 60, wherein the information relating to the performance of the one or more timing services relates to a performance quality of the one or more timing services and the information relating to the performance of the one or more timing services comprises:
an internal timing accuracy of the UE;
an indication of a Quality of Service, QoS, metric or a Quality of Experience, QoE, metric associated with the one or more timing services;
an indication of an accuracy of time information provided to the one or more UEs or a second network node for a QoS flow and/or the timing service.
an indication of a phase stability and/or a frequency stability of the one or more timing services;
an indication that one or more requirements of the one or more timing services provided to the one or more UEs were fulfilled;
an indication that one or more requirements of the one or more timing services provided to the one or more UEs were not fulfilled;
an indication that the one or more timing services provided to the one or more UEs were subject to one or more temporary interruptions;
an indication that the one or more timing services provided to the one or more UEs were subject to one or more permanent failures;
an indication of a confidence level of the one or more UEs or a second network node in one or more estimates of a quality of the one or more timing services;
an indication of a position of the one or more UEs when a measurement procedure to measure the performance of the timing service is performed by the one or more UEs;
an indication of a time at which a measurement procedure to measure the performance of the one or more timing service is performed by the one or more UEs or a second network node;
an indication of one or more radio channel conditions observed by the one or more UEs whilst performing a measurement procedure to measure the performance of the timing services; and
an indication of one or more radio channel conditions observed by a second network node whilst performing a measurement procedure to measure the performance of the one or more timing services.

69. The method of claim 60, wherein the information relating to the performance of the one or more timing services is transmitted to the first network node from the one or more UEs in one or more Minimization of Drive Test (MDT) reports.

70. A method performed by a second network node of a communication network, the method comprising:
collecting information relating to the performance of one or more timing services provided to the one or more UEs by the communication network; and
transmitting, to a first network node of the communication network, a report message comprising the information relating to performance of the one or more timing services provided to one or more UEs by the communication network.

71. The method of claim 70, wherein the information relating to the performance of the one or more timing services is collected from an application layer of the communication network.

72. The method of claim 70, wherein the information relating to the performance of the one or more timing services is collected whilst the one or more timing services are being provided to the one or more UEs.

73. The method of claim 70, wherein the information relating to the performance of the one or more timing services is collected after provision of the one or more timing services to the one or more UEs has stopped.

74. The method of claim 70, wherein the information relating to the performance of the one or more timing services relates to a performance quality of the one or more timing services and wherein the information relating to the performance of the timing service comprises one or more of:
an internal timing accuracy of the UE;
an indication of a Quality of Service, QoS, or Quality of Experience, QoE, associated with the one or more timing services;
an indication of an accuracy of time information provided to the second network node for a QoS flow and/or the one or more timing services;
an indication of a phase stability and/or a frequency stability of the one or more timing services;
an indication that one or more requirements of the one or more timing service provided to the one or more UEs were fulfilled;
an indication that one or more requirements of the one or more timing services provided to the one or more UEs were not fulfilled;
an indication that the one or more timing services provided to the one or more UEs were subject to one or more temporary interruptions;
an indication that the one or more timing services provided to the one or more UEs were subject to one or more permanent failures;
an indication of a confidence level of the second network node in one or more estimates of a quality of the one or more timing services;
an indication of a time at which the second network node performs a measurement procedure to measure the performance of the timing service; and
an indication of one or more radio channel conditions observed by the second network node whilst performing a measurement procedure to measure the performance of the one or more timing services.

75. The method of claim 70, wherein the information relating to the performance of the timing services is specific to:
the one or more UEs;
one or more Packet Data Unit (PDU) Sessions for the one or more UEs;
one or more Quality of Service (QoS) Flows for one or more PDU Sessions for the one or more UEs; or
a UE group, wherein the UE group comprises the one or more UEs.

76. The method of claim 70, wherein the second network node is an Access & Mobility Management Function (AMF) and the first network node is a Radio Access Network (RAN) node.

77. The method of claim 70, wherein the one or more timing services are any one or more of:
a Time-as-a-Service (TaaS) service;
a timing service used for Ultra Reliable and Low Latency Communication (URLLC); or
a timing service used for time critical communication.

78. A User Equipment (UE), the UE comprising a processor and a memory, the memory containing instructions executable by the processor such that the UE is configured to:
collect information relating to the performance of the timing service provided to UE by the communication network;
transmit, to a first network node of a communication network, a report message comprising the information relating to performance of the timing service provided to the UE by the communication network;
wherein collecting the information relating to the performance of the timing service comprises at least one of:
performing a measurement procedure to measure the performance of the timing service; and
receiving, from an end application connected to the UE, the information relating to the performance of the timing service.
